(19) United States
(12) Patent Application Publication
(10) Pub. No.: US 2026/0222665 A1
(43) Pub. Date: Jul. 30, 2026

(54) OPTICAL DEVICE AND IMAGING UNIT INCLUDING OPTICAL DEVICE

(71) Applicant: Murata Manufacturing Co., Ltd., Nagaokakyo-shi (JP)

(72) Inventor: Shigehisa YAGO, Nagaokakyo-shi (JP)

(21) Appl. No.: 19/578,130

(22) Filed: Mar. 25, 2026

Related U.S. Application Data
(63) Continuation of application No. PCT/JP2024/021167, filed on Jun. 11, 2024.

(30) Foreign Application Priority Data
Oct. 20, 2023 (JP) 2023-180928

(51) Int. Cl. H04N 23/55; G02B 7/02; H04N 23/51

(52) U.S. Cl. CPC H04N 23/55; G02B 7/028; H04N 23/51

(57) ABSTRACT

An optical device includes a light-transmitting member that transmits light of a predetermined wavelength, a housing that holds the light-transmitting member, a piezoelectric element, a first vibrating member that vibrates the light-transmitting member by vibration of the piezoelectric element, and a second vibrating member that has a damping coefficient smaller than a damping coefficient of the light-transmitting member and that vibrates together with the light-transmitting member by being in contact with the light-transmitting member.

### CROSS REFERENCE TO RELATED APPLICATIONS

This application is a continuation of International Application No. PCT/JP2024/021167, filed June 11, 2024, which claims priority to Japanese Patent Application No. JP 2023-180928, filed January 20, 2023, the entire contents of each of which are hereby incorporated by reference in their entirety.

### TECHNICAL FIELD

The present disclosure relates to an optical device and an imaging unit that includes an optical device.

### BACKGROUND OF THE INVENTION

A technology for controlling a safety device or performing driving support control by utilizing an image obtained by an imaging unit provided at a front portion or a rear portion of a vehicle is known. Since such an imaging unit is often provided outside a vehicle, for example, in cold weather, ice or frost may sometimes adhere to a surface of a light-transmitting member that covers the exterior of the imaging unit, so that there is a possibility that a clear image cannot be obtained.

In this regard, U.S. Patent Application Publication No. 2018/0246323 (the “’323 Publication”) discloses a camera lens cover system for heating a light-transmitting member by vibration.

According to the camera lens cover system disclosed in the ’323 Publication, ice or frost adhering to a surface of a light-transmitting member can be removed by heating the light-transmitting member by vibration. However, regarding the camera lens cover system described above, there is a possibility that the light-transmitting member cannot be sufficiently heated by vibration in a situation where there are various constraints, such as constraints regarding a temperature rise rate of the light-transmitting member, constraints regarding power consumption when vibrating the light-transmitting member, and constraints regarding a structure for vibrating the light-transmitting member.

### SUMMARY OF THE INVENTION

According to an exemplary aspect of the disclosure, a technology for sufficiently heating a light-transmitting member by vibration in a situation where there are constraints.

An optical device according to an aspect of the present disclosure includes a light-transmitting member that transmits light of a predetermined wavelength, a housing that holds the light-transmitting member, a piezoelectric element, a first vibrating member that vibrates the light-transmitting member by vibration of the piezoelectric element, and a second vibrating member that has a damping coefficient smaller than a damping coefficient of the light-transmitting member and that vibrates together with the light-transmitting member by being in contact with the light-transmitting member.

An imaging unit according to another aspect of the present disclosure includes the optical device and an imaging element that is arranged such that the light-transmitting member is located in a viewing direction.

According to the present disclosure, in addition to heating the light-transmitting member by vibration of the first vibrating member, the light-transmitting member can be heated by vibration of the second vibrating member that is in contact with the light-transmitting member. In addition, since the second vibrating member has a damping coefficient smaller than the damping coefficient of the light-transmitting member, the second vibrating member can generate heat by vibration to a temperature higher than a temperature of the light-transmitting member, and the light-transmitting member can be quickly heated by transmitting the thermal energy of the second vibrating member to the light-transmitting member. As a result, the present disclosure can sufficiently heat the light-transmitting member by vibration in a situation where there are constraints.

Additional advantages and novel features of the system of the present disclosure will be set forth in part in the description that follows, and in part will become more apparent to those skilled in the art upon examination of the following or upon learning by practice of the disclosure.

### BRIEF DESCRIPTION OF DRAWINGS

In the descriptions that follow, like parts are marked throughout the specification and drawings with the same numerals, respectively. The drawings are not necessarily drawn to scale and certain drawings may be shown in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1 is a diagram illustrating a half cross section of an imaging unit in accordance with aspects of the present disclosure;

FIG. 2 is a half cross-sectional diagram of a vibration simulation model corresponding to the imaging unit in accordance with aspects of the present disclosure;

FIG. 3 is a diagram illustrating a result of vibration simulation using the vibration simulation model in accordance with aspects of the present disclosure;

FIG. 4 is a diagram illustrating a half cross section of an imaging unit in accordance with aspects of the present disclosure;

FIG. 5 is a diagram illustrating a half cross section of an imaging unit in accordance with aspects of the present disclosure;

FIG. 6 is a diagram illustrating a half cross section of an imaging unit in accordance with aspects of the present disclosure; and

FIG. 7 is a diagram illustrating a half cross section of an imaging unit in accordance with aspects of the present disclosure.

### DETAILED DESCRIPTION

Hereinbelow, aspects of the present disclosure will be described. In a following description of the drawings, the same or similar components will be represented with use of the same or similar reference characters. The drawings are exemplary, sizes or shapes of portions are schematic, and technical scope of the present disclosure should not be understood with limitation to the aspects.

An optical device and an imaging unit that includes an optical device according to aspects of the present disclosure will be described in detail below with reference to the drawings. Note that, in the drawings, the same reference numerals are assigned to the same or corresponding portions. An imaging unit described below is attached to, for example, a front portion or a rear portion of a vehicle and acquires information such as a shape, a color, and a temperature of an object that is present in the vicinity of the vehicle, and information such as a distance from the vehicle to the object. Note that the imaging unit is not limited to being attached to a vehicle, and may be attached to another apparatus such as a ship or an aircraft. In addition, the optical device may be applied to, for example, not only a vehicle-mounted imaging unit but also a monitoring camera for security, an imaging unit for a drone, or the like.

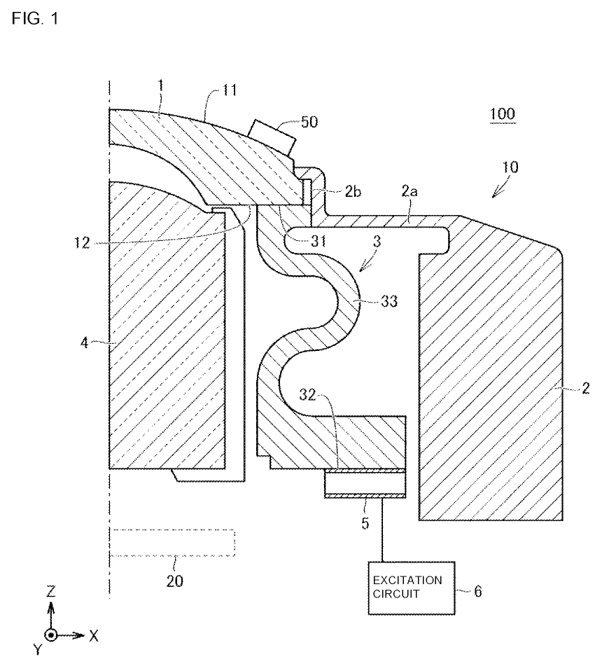

An optical device 10 according to an aspect of the present disclosure and an imaging unit 100 that includes the optical device 10 according an aspect of the present disclosure will be described with reference to FIG. 1 to FIG. 3. FIG. 1 is a diagram illustrating a half cross section of the imaging unit 100 according to an aspect of the present disclosure. Note that, in the drawings, the X direction, the Y direction, and the Z direction indicate a lateral direction, a width (depth) direction, and a height direction of the imaging unit 100, respectively. In addition, a dash-dotted line passes through the central axis of the imaging unit 100.

As illustrated in FIG. 1, the imaging unit 100 includes the optical device 10 and an imaging element 20.

The optical device 10 includes an outermost layer lens 1, a housing 2, a first vibrating member 3, an inner layer lens 4, a piezoelectric element 5, and an excitation circuit 6, and is configured so as to guide light to the imaging element 20. Note that it is only necessary for the optical device 10 to include at least the outermost layer lens 1, the housing 2, the first vibrating member 3, and the piezoelectric element 5, and neither the inner layer lens 4 nor the excitation circuit 6 needs to be included. In this case, the inner layer lens 4 and the excitation circuit 6 may be included in the imaging unit 100 as a configuration separate from the optical device 10. The optical device 10 is attached to a case including the imaging element 20 after alignment adjustment of the outermost layer lens 1 and the inner layer lens 4 has been performed, so that the imaging unit 100 is assembled.

The imaging element 20 is, for example, an image sensor such as a charge-coupled device (CCD) sensor or a complementary metal-oxide-semiconductor (CMOS) sensor and acquires information such as a shape, a color, and a temperature of an object, and information such as a distance from a vehicle to the object. Note that the imaging element 20 may be formed by a light detection and ranging (LiDAR) or the like using a laser. The imaging element 20 is arranged such that the outermost layer lens 1 and the inner layer lens 4 of the optical device 10 are located in a viewing direction and is mounted on a circuit board (not illustrated).

The outermost layer lens 1 is an example of a "light-transmitting member". The outermost layer lens 1 includes a first surface 11 (e.g., a front surface) that is positioned on an outer side of the optical device 10 and a second surface 12 (e.g., a rear surface) that is positioned on an inner side of the optical device 10. The outermost layer lens 1 transmits light of a predetermined wavelength (e.g., a wavelength of visible light, a wavelength for being captured by an imaging element, or the like). The outermost layer lens 1 is formed by, for example, a convex meniscus lens. Note that the optical device 10 may include a transparent member such as a protection cover as the "light-transmitting member" instead of the outermost layer lens 1. A protection cover used as the "light-transmitting member" is made of glass, a resin such as a transparent plastic, or a light-transmitting ceramic. Note that examples of the resin used for the protection cover include acrylic, cycloolefin, polycarbonate, and polyester.

The housing 2 holds the outermost layer lens 1. Specifically, the optical device 10 further includes a plate spring 2a extending from the housing 2 and a retainer 2b for fixing the outermost layer lens 1 to the plate spring 2a of the housing 2. An end portion of the outermost layer lens 1 in the X direction is held by the retainer 2b provided at an end portion of the plate spring 2a. For example, an adhesive is filled between the end portion of the outermost layer lens 1 in the X direction and the retainer 2b provided at the end portion of the plate spring 2a in the X direction. Note that the end portion of the outermost layer lens 1 and the retainer 2b may be connected to each other by welding, fitting, press-fitting, or the like. In addition, in the case illustrated in FIG. 1, although the housing 2 holds the outermost layer lens 1 directly via the retainer 2b, another member may be provided between the outermost layer lens 1 and the housing 2, and the housing 2 may hold the outermost layer lens 1 indirectly via the other member. The housing 2 and the plate spring 2a are made of a metal such as, for example, stainless steel (SUS: Steel Use Stainless) or aluminum. Note that the housing 2 and the plate spring 2a may be made of a resin.

he first vibrating member 3 is provided at a position so as to be in contact with the outermost layer lens 1 and vibrates the outermost layer lens 1, which is held by the housing 2, by vibration of the piezoelectric element 5. For example, the first vibrating member 3 has the shape of a cylindrical body and is formed so as to connect a first end portion 31 of the first vibrating member 3 in the Z direction and a second end portion 32 of the first vibrating member 3 in the Z direction by a support portion 33. The second surface 12 of the outermost layer lens 1 is in contact with the first end portion 31 of the first vibrating member 3, and the piezoelectric element 5 is in contact with the second end portion 32 of the first vibrating member 3. The inner layer lens 4 is disposed inside the cylinder of the first vibrating member 3.

The first end portion 31 of the first vibrating member 3 has a shape extending in a radial direction (X and Y directions) of the cylindrical body and can be stably in contact with the second surface 12 of the outermost layer lens 1. The second end portion 32 of the first vibrating member 3 vibrates along with the vibration of the piezoelectric element 5 and has a plate thickness in the Z direction larger than that of another portion (e.g., the first end portion 31) in the first vibrating member 3. Accordingly, the first vibrating member 3 can efficiently transmit the vibration of the piezoelectric element 5 to the outermost layer lens 1.

The support portion 33 supports the first end portion 31 and transmits vibration of the piezoelectric element 5 (vibration of the second end portion 32) to the first end portion 31. Note that the first end portion 31, the second end portion 32, and the support portion 33 may be formed integrally or may be formed individually. A maximum outer dimension of the support portion 33 in the X direction is larger than a maximum outer dimension of the first end portion 31 in the X direction. In addition, a maximum outer dimension of the second end portion 32 in the X direction is larger than the maximum outer dimension of the support portion 33 in the X direction. Accordingly, the first vibrating member 3 can efficiently transmit the vibration of the piezoelectric element 5 (vibration of the second end portion 32) to the outermost layer lens 1.

The piezoelectric element 5 has a hollow circular shape and vibrates, for example, by being polarized in the thickness direction (Z direction). The piezoelectric element 5 is connected to the excitation circuit 6 and vibrates the outermost layer lens 1 by vibrating the first vibrating member 3 based on a signal from the excitation circuit 6. For example, the piezoelectric element 5 is made of a lead zirconate titanate-based piezoelectric ceramic. Note that the piezoelectric element 5 may be made of another piezoelectric ceramic such as (K,Na)NbO3 or may be made of a piezoelectric single crystal such as LiTaO3.

The excitation circuit 6 is configured to vibrate the outermost layer lens 1 at a frequency corresponding to a predetermined vibration mode. Specifically, the excitation circuit 6 can drive the piezoelectric element 5 by switching a mode to any one of a plurality of vibration modes including a foreign matter removal mode and a heating mode.

The excitation circuit 6 vibrates the outermost layer lens 1 at a resonant frequency (e.g., approximately 50 kHz) of the first vibrating member 3 by driving the piezoelectric element 5 in the foreign matter removal mode, so that foreign matter such as raindrops, mud, or dust adhering to the outermost layer lens 1 can be removed.

The excitation circuit 6 vibrates the outermost layer lens 1 at a natural vibration frequency (e.g., approximately 500 kHz) of the outermost layer lens 1 by driving the piezoelectric element 5 in the heating mode, so that foreign matter such as ice or frost adhering to the outermost layer lens 1 can be removed.

In the heating mode, the imaging unit 100 heats the outermost layer lens 1 by utilizing mechanical loss caused by vibrating the outermost layer lens 1. In order to efficiently heat the outermost layer lens 1, the imaging unit 100 needs to vibrate the outermost layer lens 1 at the natural vibration frequency of the outermost layer lens 1. However, even if the outermost layer lens 1 is vibrated at the natural vibration frequency, while foreign matter such as ice or frost adheres to the outermost layer lens 1, the imaging unit 100 cannot capture a necessary image. Thus, in a vehicle-mounted system or the like in which the imaging unit 100 is incorporated, the time from the removal of foreign matter such as ice or frost in the heating mode until a necessary image can be captured (hereinafter also referred to as an "allowable wait time") is limited.

The optical device 10 needs to increase a temperature rise rate of the outermost layer lens 1 in order to raise a temperature of the outermost layer lens 1 to a temperature at which a necessary image can be captured within the time limit of the allowable wait time. However, if the optical device 10 increases the vibration acceleration of the outermost layer lens 1 in order to increase the temperature rise rate of the outermost layer lens 1, the power consumption of the piezoelectric element 5 increases accordingly. In a vehicle-mounted system or the like in which the imaging unit 100 is incorporated, power consumption allocated to the imaging unit 100 (hereinafter, also referred to as "allowable power consumption") is often limited. Thus, the optical device 10 needs to increase the temperature rise rate of the outermost layer lens 1 by driving the piezoelectric element 5 within the range of the allowable power consumption.

In addition, the temperature rise rate of the outermost layer lens 1 can be increased by devising a structure for vibrating the outermost layer lens 1, such as the shapes or the arrangement of the outermost layer lens 1, the first vibrating member 3, and the housing 2. However, in a vehicle-mounted system or the like in which the imaging unit 100 is incorporated, the shapes or the arrangement of the outermost layer lens 1, the first vibrating member 3, and the housing 2 are often limited due to the structure.

Accordingly, the optical device 10 of the imaging unit 100 according to an aspect of the present disclosure is configured such that the outermost layer lens 1 can be sufficiently heated by vibration in a situation where there are various constraints, such as constraints regarding the temperature rise rate of the outermost layer lens 1, constraints regarding power consumption of the piezoelectric element 5 when vibrating the outermost layer lens 1, and constraints regarding the structure for vibrating the outermost layer lens 1.

Specifically, the optical device 10 further includes a second vibrating member 50 that is in contact with the outermost layer lens 1. Here, the phrase "in contact with" refers to at least one of a case where the second vibrating member 50 is directly in contact with the outermost layer lens 1 and a case where the second vibrating member 50 is indirectly in contact with the outermost layer lens 1. For example, the second vibrating member 50 may be attached to the outermost layer lens 1 with an adhesive or an adhesive tape so as to be directly in contact with the outermost layer lens 1. Alternatively, the second vibrating member 50 may be indirectly in contact with the outermost layer lens 1 via another member provided between the second vibrating member 50 and the outermost layer lens 1.

As illustrated in FIG. 1, in the optical device 10 according to an aspect of the present disclosure, the second vibrating member 50 is in contact with the first surface 11 that is the front surface of the outermost layer lens 1, and vibrates together with the outermost layer lens 1. Note that an attachment position of the second vibrating member 50 on the first surface 11 of the outermost layer lens 1 may be any position as long as an optical influence (e.g., a viewing angle or the like) on the imaging element 20 does not occur. When the outermost layer lens 1 vibrates as a result of transmission of vibration of the first vibrating member 3 that is caused to vibrate by the piezoelectric element 5, the second vibrating member 50, which is in contact with the first surface 11 of the outermost layer lens 1, also vibrates.

In addition, the second vibrating member 50 has a damping coefficient smaller than a damping coefficient of the outermost layer lens 1. For example, the second vibrating member 50 is made of a resin such as a plastic. An example of the resin used for the second vibrating member 50 is polyphenylene sulfide (PPS: Poly Phenylene Sulfide). Note that the material of the outermost layer lens 1 and the material of the second vibrating member 50 may be made of any material as long as the damping coefficient of the second vibrating member 50 is lower than the damping coefficient of the outermost layer lens 1. For the second vibrating member 50, a material having a damping coefficient according to a heat amount required to cause the outermost layer lens 1 to generate heat may be selected. By selecting the material of the second vibrating member 50 according to the shape of the outermost layer lens 1, a required range of the temperature rise rate of the outermost layer lens 1, or the like, the temperature rise rate of the outermost layer lens 1 can be controlled.

Since the second vibrating member 50 has the damping coefficient smaller than the damping coefficient of the outermost layer lens 1, a heat generation amount of the second vibrating member 50 according to strain caused by vibration becomes larger than a heat generation amount of the outermost layer lens 1 according to strain caused by vibration. In other words, even in a case where the second vibrating member 50 and the outermost layer lens 1 vibrate in the same manner, a temperature rise rate of the second vibrating member 50 becomes larger than the temperature rise rate of the outermost layer lens 1.

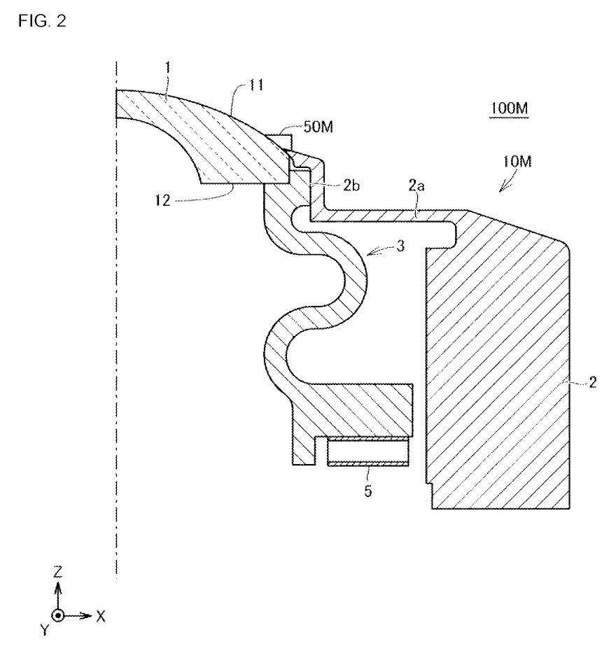

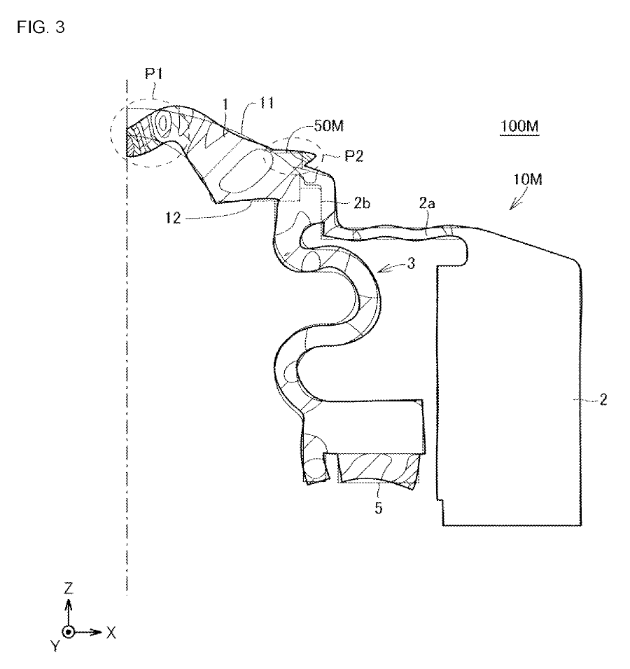

Here, an example of vibration simulation using a vibration simulation model corresponding to the imaging unit 100 will be described with reference to FIG. 2 and FIG. 3. FIG. 2 is a half cross-sectional diagram of the vibration simulation model corresponding to the imaging unit 100 according to an aspect of the present disclosure .

As illustrated in FIG. 2, an imaging unit 100M that includes an optical device 10M is used as the vibration simulation model corresponding to the imaging unit 100 according to an aspect of the present disclosure. The optical device 10M includes, as a configuration corresponding to the second vibrating member 50, a second vibrating member 50M that is in contact with the first surface 11, which is the front surface of the outermost layer lens 1.

FIG. 3 is a diagram illustrating a result of vibration simulation using the vibration simulation model according to an aspect of the present disclosure. FIG. 3 illustrates displacement due to vibration generated in the optical device 10M as a result of performing the vibration simulation using the imaging unit 100M of FIG. 2. Note that, in FIG. 3, a magnitude of displacement due to vibration is illustrated by using different hatching densities, and a portion with large displacement due to vibration is illustrated as a portion with dark hatching.

As illustrated by P1 in FIG. 3, the outermost layer lens 1 is caused to vibrate by the first vibrating member 3, so that the outermost layer lens 1 is significantly deformed particularly in the vicinity of a center portion thereof. In addition, as illustrated by P2 in FIG. 3, the second vibrating member 50 is also significantly deformed by vibrating together with the outermost layer lens 1. In other words, the outermost layer lens 1 is for efficiently generating heat by concentrating vibration in the vicinity of the center portion, and can more quickly generating heat by transmission of thermal energy generated by vibration of the second vibrating member 50.

In this manner, the optical device 10 can heat the outermost layer lens 1 by vibration of the second vibrating member 50, which is in contact with the outermost layer lens 1, in addition to heating the outermost layer lens 1 by vibration of the first vibrating member 3. In addition, since the second vibrating member 50 has the damping coefficient smaller than the damping coefficient of the outermost layer lens 1, the second vibrating member 50 can generate heat by vibration to a temperature higher than that of the outermost layer lens 1, and the outermost layer lens 1 can be quickly heated by transmitting the thermal energy of the second vibrating member 50 to the outermost layer lens 1.

As a result, the optical device 10 can sufficiently heat the outermost layer lens 1 by using vibration of the second vibrating member 50, which is in contact with the outermost layer lens 1, in a situation where there are various constraints, such as constraints regarding the temperature rise rate of the outermost layer lens 1, constraints regarding power consumption of the piezoelectric element 5 when vibrating the outermost layer lens 1, and constraints regarding the structure for vibrating the outermost layer lens 1.

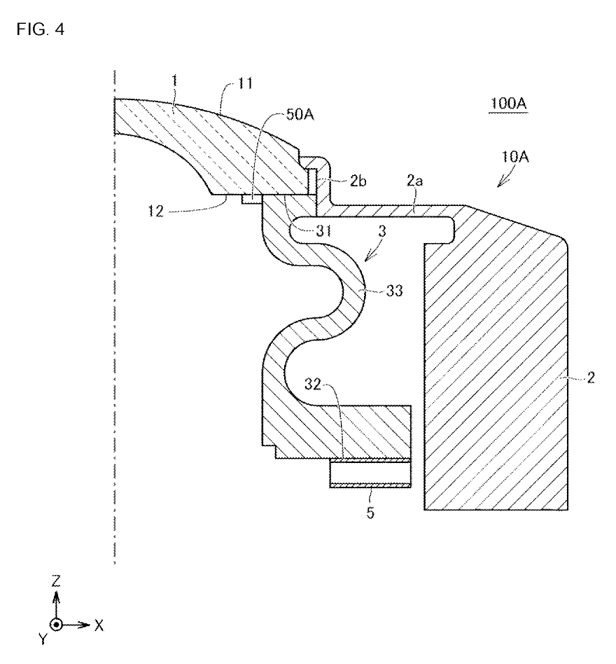

An optical device 10A according to an aspect of the present disclosure and an imaging unit 100A that includes the optical device 10A according to an aspect of the present disclosure will be described below with reference to FIG. 4. In the following description, regarding the optical device 10A and the imaging unit 100A according to an aspect of the present disclosure, only portions different from those of the optical device 10 and the imaging unit 100 according aspect described above will be described, and descriptions of other portions may sometimes be omitted.

FIG. 4 is a diagram illustrating a half cross section of the imaging unit 100A according to an aspect of the present disclosure. As illustrated in FIG. 4, in the imaging unit 100A according to an aspect of the present disclosure, the optical device 10A includes a second vibrating member 50A that is in contact with the second surface 12, which is the rear surface of the outermost layer lens 1.

Note that the attachment position of the second vibrating member 50A on the second surface 12 of the outermost layer lens 1 may be any position as long as an optical influence (e.g., a viewing angle or the like) on the imaging element 20 does not occur.

When the outermost layer lens 1 vibrates as a result of transmission of vibration of the first vibrating member 3, which is caused to vibrate by the piezoelectric element 5, the second vibrating member 50A that is in contact with the second surface 12 of the outermost layer lens 1 also vibrates. Thermal energy generated by vibration of the second vibrating member 50A is transmitted to the outermost layer lens 1.

In this manner, the optical device 10A according to an aspect of the present disclosure utilizes the second vibrating member 50A, which is in contact with the second surface 12 of the outermost layer lens 1, and thereby can heat the outermost layer lens 1 by the vibration of the second vibrating member 50A, in addition to heating the outermost layer lens 1 by the vibration of the first vibrating member 3. In addition, since the second vibrating member 50A has a damping coefficient smaller than the damping coefficient of the outermost layer lens 1, the second vibrating member 50A can generate heat by vibration to a temperature higher than that of the outermost layer lens 1, and the outermost layer lens 1 can be quickly heated by transmitting the thermal energy of the second vibrating member 50A to the outermost layer lens 1. Furthermore, since the second vibrating member 50A is arranged on the side of the second surface 12 of the outermost layer lens 1 where an optical influence (e.g., a viewing angle or the like) is less likely to occur, a degree of freedom in the attachment position of the second vibrating member 50A increases, and a degree of freedom in the design of the outermost layer lens 1 also increases.

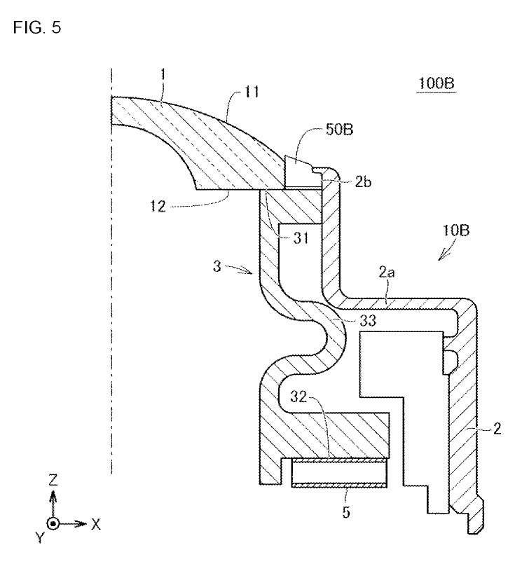

An optical device 10B according to an aspect of the present disclosure and an imaging unit 100B including the optical device 10B according to an aspect of the present disclosure will be described with reference to FIG. 5. In the following description, regarding the optical device 10B and the imaging unit 100B according to an aspect of the present disclosure, only portions different from those of the optical device 10 and the imaging unit 100 according to aspects described above will be described, and descriptions of other portions may sometimes be omitted.

FIG. 5 is a diagram illustrating a half cross section of the imaging unit 100B according to an aspect of the present disclosure. As illustrated in FIG. 5, in the imaging unit 100B according to an aspect of the present disclosure, the optical device 10B includes a second vibrating member 50B disposed between the outermost layer lens 1 and a retainer 2b. The second vibrating member 50B has a function as a spacer that fills a gap between the outermost layer lens 1 and the retainer 2b, in addition to a function of heating the outermost layer lens 1.

The second vibrating member 50B is in contact with an end portion of the outermost layer lens 1 in the X direction and is in contact with the retainer 2b in the X direction. In the case illustrated in FIG. 5, the second vibrating member 50B is also in contact with the first end portion 31 of the first vibrating member 3 in the Z direction. An area where the second vibrating member 50B and the outermost layer lens 1 are in contact with each other is larger than an area where the second vibrating member 50B and the retainer 2b are in contact with each other.

The second vibrating member 50B has a thermal conductivity smaller than a thermal conductivity of each of the outermost layer lens 1 and the retainer 2b. When the outermost layer lens 1 vibrates as a result of transmission of vibration of the first vibrating member 3, which is caused to vibrate by the piezoelectric element 5, the second vibrating member 50B that is in contact with the outermost layer lens 1 also vibrates. In addition, since the second vibrating member 50B is also in contact with the first vibrating member 3, the second vibrating member 50B also vibrates as a result of transmission of vibration of the first vibrating member 3. Thermal energy generated by vibration of the second vibrating member 50B is transmitted to the outermost layer lens 1.

In this manner, the optical device 10B according to an aspect of the present disclosure utilizes the second vibrating member 50B disposed between the outermost layer lens 1 and the retainer 2b, and can heat the outermost layer lens 1 by the vibration of the second vibrating member 50B, in addition to heating the outermost layer lens 1 by vibration of the first vibrating member 3. In addition, since the second vibrating member 50B has a damping coefficient smaller than the damping coefficient of the outermost layer lens 1, the second vibrating member 50B can generate heat by vibration to a temperature higher than that of the outermost layer lens 1, and the outermost layer lens 1 can be quickly heated by transmitting the thermal energy of the second vibrating member 50B to the outermost layer lens 1.

In addition, since the area where the second vibrating member 50B and the outermost layer lens 1 are in contact with each other is larger than the area where the second vibrating member 50B and the retainer 2b are in contact with each other, the thermal energy of the second vibrating member 50B is more easily transmitted to the outermost layer lens 1 than to the retainer 2b. Furthermore, since the thermal conductivity of the second vibrating member 50B is smaller than the thermal conductivity of each of the outermost layer lens 1 and the retainer 2b, transmission of the thermal energy of the outermost layer lens 1 to the retainer 2b via the second vibrating member 50B can be suppressed.

Furthermore, in the optical device 10B according to an aspect of the present disclosure, the outermost layer lens 1 can be heated by the second vibrating member 50B, which is used as the spacer that fills the gap between the outermost layer lens 1 and the retainer 2b, and thus, it is not necessary to provide both a second vibrating member that supports heating of the outermost layer lens 1 and a spacer, so that the number of components can be reduced. The optical device 10B can appropriately fill the gap between the outermost layer lens 1 and the retainer 2b by selecting the shape of the second vibrating member 50B in accordance with the shape of the outermost layer lens 1 and the shape of the housing 2.

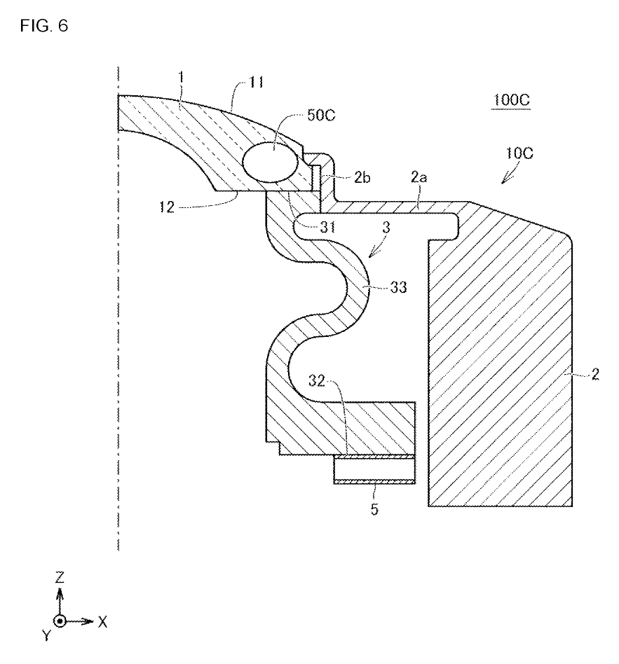

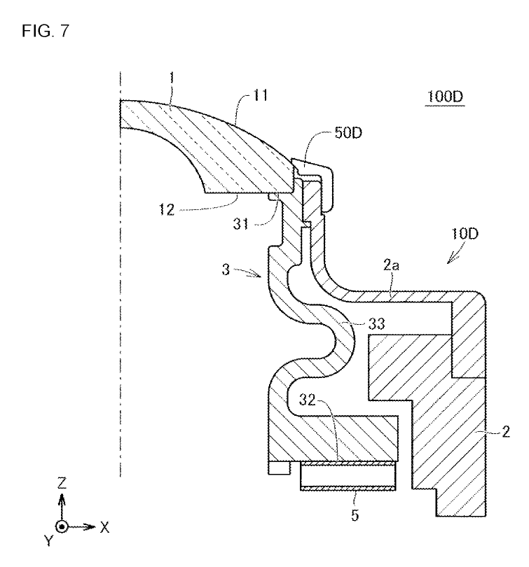

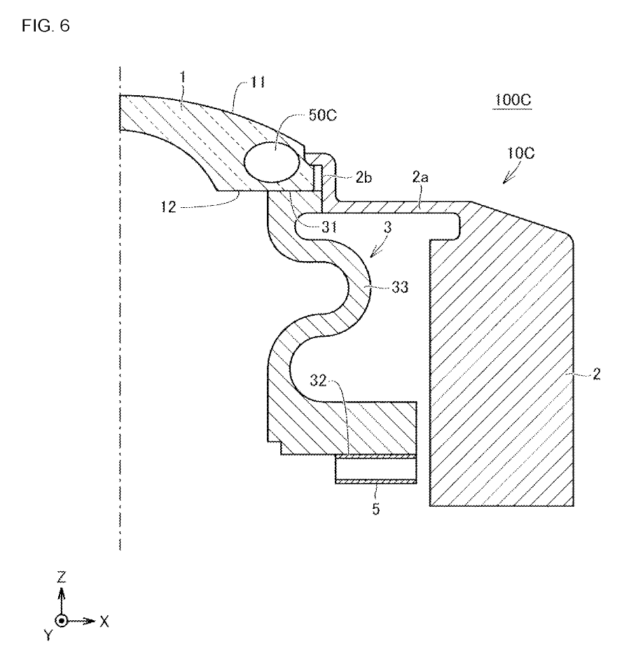

An optical device 10C according to an aspect of the present disclosure and an imaging unit 100C that includes the optical device 10C according to an aspect of the present disclosure will be described with reference to FIG. 6. In the following description, regarding the optical device 10C and the imaging unit 100C according to an aspect of the present disclosure, only portions different from those of the optical device 10 and the imaging unit 100 according to aspects described above will be described, and descriptions of other portions may sometimes be omitted.

FIG. 6 is a diagram illustrating a half cross section of the imaging unit 100C according to an aspect of the present disclosure. As illustrated in FIG. 6, in the imaging unit 100C according to an aspect of the present disclosure, the optical device 10C includes a second vibrating member 50C that is embedded inside the outermost layer lens 1 and that is in contact with the inside of the outermost layer lens 1. Note that an embedding position of the second vibrating member 50C inside the outermost layer lens 1 may be any position as long as an optical influence (e.g., a viewing angle or the like) on the imaging element 20 does not occur.

When the outermost layer lens 1 vibrates as a result of transmission of vibration of the first vibrating member 3, which is caused to vibrate by the piezoelectric element 5, the second vibrating member 50C that is in contact with the inside of the outermost layer lens 1 also vibrates. Thermal energy generated by vibration of the second vibrating member 50C is transmitted to the outermost layer lens 1.

In this manner, the optical device 10C according to an aspect of the present disclosure utilizes the second vibrating member 50C, which is in contact with the inside of the outermost layer lens 1, and can heat the outermost layer lens 1 by the vibration of the second vibrating member 50C, in addition to heating the outermost layer lens 1 by the vibration of the first vibrating member 3. In addition, since the second vibrating member 50C has a damping coefficient smaller than the damping coefficient of the outermost layer lens 1, the second vibrating member 50C can generate heat by vibration to a temperature higher than that of the outermost layer lens 1, and the outermost layer lens 1 can be quickly heated by transmitting the thermal energy of the second vibrating member 50C to the outermost layer lens 1. Furthermore, since the second vibrating member 50C is embedded inside the outermost layer lens 1 and is integrated with the outermost layer lens 1, a step for attaching the second vibrating member 50C to the front surface of the outermost layer lens 1 can be omitted, and occurrence of misalignment of the second vibrating member 50C can be avoided.

An optical device 10D according to an aspect of the present disclosure and an imaging unit 100D including the optical device 10D according to an aspect of the present disclosure will be described with reference to FIG. 7. In the following description, regarding the optical device 10D and the imaging unit 100D according to an aspect of the present disclosure, only portions different from those of the optical device 10 and the imaging unit 100 according to aspects described above will be described, and descriptions of other portions may sometimes be omitted.

FIG. 7 is a diagram illustrating a half cross section of the imaging unit 100D according to an aspect of the present disclosure. As illustrated in FIG. 7, in the imaging unit 100D according to an aspect of the present disclosure, the optical device 10D includes a second vibrating member 50D that is in contact with the outermost layer lens 1 and with the plate spring 2a and that fixes the outermost layer lens 1 to the plate spring 2a. In the optical device 10D, a portion of the first vibrating member 3 is arranged so as to be sandwiched between the outermost layer lens 1 and the plate spring 2a extending from the housing 2. The housing 2 indirectly holds the outermost layer lens 1 via the portion of the first vibrating member 3. The second vibrating member 50D has a function as a retainer for fixing the outermost layer lens 1 to the portion of the first vibrating member 3 and to the plate spring 2a. In other words, the second vibrating member 50D has a function of heating the outermost layer lens 1, and in addition, has a function as a retainer that prevents the outermost layer lens 1, which is held by the housing 2 via the portion of the first vibrating member 3 and the plate spring 2a, from falling off the housing 2.

When the outermost layer lens 1 vibrates as a result of transmission of vibration of the first vibrating member 3, which is caused to vibrate by the piezoelectric element 5, the second vibrating member 50D that is in contact with the outermost layer lens 1 also vibrates. Thermal energy generated by vibration of the second vibrating member 50D is transmitted to the outermost layer lens 1.

In this manner, the optical device 10D according to an aspect of the present disclosure utilizes the second vibrating member 50D that fixes the outermost layer lens 1 to the plate spring 2a, and can heat the outermost layer lens 1 by the vibration of the second vibrating member 50D, in addition to heating the outermost layer lens 1 by the vibration of the first vibrating member 3. In addition, since the second vibrating member 50D has a damping coefficient smaller than the damping coefficient of the outermost layer lens 1, the second vibrating member 50D can generate heat by vibration to a temperature higher than that of the outermost layer lens 1, and the outermost layer lens 1 can be quickly heated by transmitting the thermal energy of the second vibrating member 50D to the outermost layer lens 1.

Furthermore, since the optical device 10D according to an aspect of the present disclosure can heat the outermost layer lens 1 by using the second vibrating member 50D, which is used as a retainer that prevents the outermost layer lens 1 from falling off the plate spring 2a, it is not necessary to provide both a second vibrating member that supports heating of the outermost layer lens 1 and a retainer, and the number of components can be reduced.

The present disclosure is not limited to the above-described aspects, and various modifications and applications are further possible. Modifications applicable to the present disclosure will be described below.

In the above-described aspects, the cross-sectional shape of the support portion 33 is an S-shape. However, the cross-sectional shape of the support portion 33 is not limited to the S-shape as long as it is a shape that does not cause concentration of stress in the first vibrating member 3. For example, the cross-sectional shape of the support portion 33 may be a shape in which a plurality of S-shapes are connected. In addition, since it may be any cross-sectional shape that reduces portions where stress is concentrated in the support portion 33, the cross-sectional shape of the support portion 33 may be a curved shape that is half of an S-shape.

The imaging unit 100 may include a camera, a LiDAR, a Radar, or the like. In addition, a plurality of imaging units 100 may be arranged side by side.

The imaging unit 100 is not limited to an imaging unit to be provided in a vehicle, and can be applied to any imaging unit that includes an optical device and an imaging element disposed such that a light-transmitting member is located in a viewing direction, and in which foreign matter on the light-transmitting member needs to be removed

The aspects disclosed in the present disclosure are to be considered illustrative in all respects and not restrictive. The scope of the present disclosure is indicated not by the above description but by the claims, and it is intended that all modifications within the meaning and scope equivalent to the claims are included.

In general, the description of the aspects disclosed should be considered as being illustrative in all respects and not being restrictive. The scope of the present disclosure is shown by the claims rather than by the above description and is intended to include meanings equivalent to the claims and all changes in the scope. While preferred aspects of the invention have been described above, it is to be understood that variations and modifications will be apparent to those skilled in the art without departing from the scope and spirit of the invention.

### REFERENCE SIGNS LIST

1 outermost layer lens

2 housing

2a plate spring

2b retainer

3 first vibrating member

4 inner layer lens

5 piezoelectric element

6 excitation circuit

10,10A,10B,10C,10D,10M optical device

11 first surface

12 second surface

20 imaging element

31 first end portion

32 second end portion

33 support portion

50, 50A, 50B, 50C, 50D, 50M second vibrating member

100, 100A, 100B, 100C, 100D, 100M imaging unit

1. An optical device comprising:
a light-transmitting member configured to transmit light of a predetermined wavelength;
a housing configured to hold the light-transmitting member;
a piezoelectric element;
a first vibrating member configured to vibrate the light-transmitting member by vibration of the piezoelectric element; and
a second vibrating member in contact with the light-transmitting member and configured to vibrate together with the light-transmitting member and has a heat generation amount caused by a vibration larger than a heat generation amount of the light-transmitting member caused by vibration.

2. The optical device according to claim 1, wherein the second vibrating member is in direct contact with the light-transmitting member.

3. The optical device according to claim 1, wherein the second vibrating member is in contact with a first surface of the light-transmitting member, the first surface being located on an outer side.

4. The optical device according to claim 1, wherein the second vibrating member is in contact with a second surface of the light-transmitting member, the second surface being located on an inner side.

5. The optical device according to claim 1, further comprising a retainer configured to fix the light-transmitting member to the housing.

6. The optical device according to claim 5, wherein the second vibrating member is disposed between the light-transmitting member and the retainer.

7. The optical device according to claim 6, wherein an area where the second vibrating member contacts the light-transmitting member is larger than an area where the second vibrating member contacts the retainer.

8. The optical device according to claim 6, wherein a thermal conductivity of the second vibrating member is smaller than a thermal conductivity of each of the light-transmitting member and the retainer.

9. The optical device according to claim 1, wherein the second vibrating member is disposed inside the light-transmitting member.

10. An imaging unit comprising:
an optical device comprising:
a light-transmitting member configured to transmit light of a predetermined wavelength;
a housing configured to hold the light-transmitting member;
a piezoelectric element;
a second vibrating member in contact with the light-transmitting member and vibrates together with the light-transmitting member,
wherein the second vibrating member has a heat generation amount caused by a vibration larger than a heat generation amount of the light-transmitting member caused by vibration; and
an imaging element that is arranged such that the light-transmitting member is located in a viewing direction.

11. The imaging unit according to claim 10, wherein the second vibrating member is in direct contact with the light-transmitting member.

12. The imaging unit according to claim 10, wherein the second vibrating member is in contact with a first surface of the light-transmitting member, the first surface being located on an outer side.

13. The imaging unit according to claim 10, wherein the second vibrating member is in contact with a second surface of the light-transmitting member, the second surface being located on an inner side.

14. The imaging unit according to claim 10, further comprising a retainer for fixing the light-transmitting member to the housing.

15. The imaging unit according to claim 14, wherein the second vibrating member is disposed between the light-transmitting member and the retainer.

16. The imaging unit according to claim 15, wherein an area where the second vibrating member contacts the light-transmitting member is larger than an area where the second vibrating member contacts the retainer.

17. The imaging unit according to claim 15, wherein a thermal conductivity of the second vibrating member is smaller than a thermal conductivity of each of the light-transmitting member and the retainer.

18. The imaging unit according to claim 10, wherein the second vibrating member is disposed inside the light-transmitting member.

19. An optical device comprising:
a light-transmitting member configured to transmit light;
a housing holding the light-transmitting member;
a piezoelectric element;
a first vibrating member configured to vibrate the light-transmitting member in response to vibration of the piezoelectric element; and
a second vibrating member in contact with the light-transmitting member and configured to vibrate together with the light-transmitting member, the second vibrating member being configured such that, during vibration of the light-transmitting member, the second vibrating member generates more heat from vibration than the light-transmitting member and transfers thermal energy to the light-transmitting member to heat the light-transmitting member.

20. The optical device according to claim 19, wherein the second vibrating member is disposed inside the light-transmitting member.
